(19) United States
(12) Patent Application Publication
(10) Pub. No.: US 2024/0011644 A1
(43) Pub. Date: Jan. 11, 2024

(54) HOOD VENTILATION DEVICE

(71) Applicant: Hanman LEE, Gwangju (KR)

(72) Inventor: Hanman LEE, Gwangju (KR)

(21) Appl. No.: 18/347,203

(22) Filed: Jul. 5, 2023

(30) Foreign Application Priority Data
Jul. 6, 2022 (KR) 10-2022-0083029

(51) Int. Cl. F24C 15/20; B01D 46/24; B01D 46/64; B01D 46/00; B01D 46/42; B01D 46/48

(52) U.S. Cl. CPC F24C 15/2035; F24C 15/2085; B01D 46/2403; B01D 46/64; B01D 46/0002; B01D 46/4254; B01D 46/48; B01D 2275/201; B01D 2279/35

(57) ABSTRACT

The present disclosure relates to a hood ventilation device for suctioning smoke, etc., which are produced when cooking food, with surrounding air and discharging them to the outside. The hood ventilation device includes at least: a hood; a stretchable tube connected at a first end to the hood and adjusting a distance between the hood and the grill; a filter box connected to a second end of the stretchable tube such that a bottom thereof communicates with the second end and having a spoiler to communicate with a top thereof; a filter member mounted in the filter box and capturing and removing oil of smoke flowing in the filter box through the stretchable tube; and a spring balancer mounted on the outer surface of an uppermost part of the stretchable tube, allowing the stretchable tube to move up and down, and fixing the stretchable tube at a predetermined height.

### CROSS-REFERENCE TO RELATED APPLICATION

The present application claims the benefit of priority to Korean Patent Application No. 10-2022-0083029, filed on Jul. 6, 2022, in the Korean Intellectual Property Office. The disclosures of the above-listed application is hereby incorporated by reference herein in its entirety.

### BACKGROUND OF THE INVENTION

### Field of the Invention

The present disclosure relates to a hood ventilation device, in more detail, a hood ventilation device for suctioning smoke, smells, heat, etc., which are produced when cooking food, with surrounding air and discharging them to the outside.

### Description of the Related Art

In general, a large amount of smoke is produced in cooking using a grill, and particularly, a large amount of oil is contained in the smokes that are produced when roasting meat, fish, etc., so when the smoke is not immediately discharged, not only the smell permeates clothes, but the surrounding environment may be contaminated by the oil.

Accordingly, a hood ventilation device is installed over the grills at restaurants, etc. to be able to quickly suction and discharge smoke, which is produced in cooking, to the outside.

Such a hood ventilation device has a structure that captures smells and smoke through a ventilation hood and then forcibly discharges them to the outside using a ventilation system. However, such a hood ventilation device simply only suctions and discharges smells and smoke and does not have a function of specifically filtering smells and smoke. Accordingly, the oil component, etc. contained in smoke adhere to and gradually accumulate on the inner side of the ventilation hood, which causes a severe problem in terms of sanitation.

Further, when a ventilation hood with an oil component, etc. adhering to the inner side thereof is used for a long period of time, oil stains move on the inner side of the ventilation hood toward grills and there is a high possibility of users eating grilled meat with the oil stains.

### PRIOR ART DOCUMENT

### Patent Document

Korean Patent No. 10-1261118 (Exhaust hood device for restaurant equipment provided with moving member, published on 2013 May 6.)
Korean Patent No. 10-1469130 (Ventilation hood, published on 2014 Dec. 9.)
Korean Patent Application Publication No. 10-2011-0075783 (Exhaust hood, published on 2011 Jul. 6.)

### SUMMARY OF THE INVENTION

The present disclosure has been made in an effort to solve the problems in the related art described above and an objective of the present disclosure is to provide a hood ventilation device that can improve the efficiency of removing oil in smoke through multi-filtering and can effectively prevent contamination of the inside of a stretchable tube due to oil by guiding oil adhering to a filter to the outside of the stretchable tube along a conical outer surface.

Another objective of the present disclosure is to provide a hood ventilation device that makes it each to adjust the distance between a hood and a grill.

Objectives of the present disclosure are not limited to those described above and other objectives not state herein can be clearly understood by those skilled in the art from the following description.

In order to achieve the objectives, a hood ventilation device expanding at an end of a suction unit installed to suction smoke that is produced by a grill includes: a hood positioned over the grill and collecting smoke that is produced when meat or fish is roasted on the grill; a stretchable tube connected at a first end to the hood and adjusting a distance between the hood and the grill; a filter box connected to a second end of the stretchable tube such that a bottom thereof communicates with the second end and having a spoiler mounted thereon to communicate with a top thereof; a filter member mounted in the filter box and performing a function of capturing and removing oil of smoke flowing in the filter box through the stretchable tube; and a spring balancer mounted on the outer surface of an uppermost part of the stretchable tube, allowing the stretchable tube to move up and down, and fixing the stretchable tube at a predetermined height.

According to the hood ventilation device of an embodiment of the present disclosure, the spring balancer has a rotary pulley on which a wire is wound and that is formed on an outer surface of the uppermost part of the stretchable tube, and includes a bracket disposed under the rotary pulley and having a plurality of guide rollers for guiding the wire wound on the rotary pulley to a fixing portion formed under the bracket.

In this embodiment, the hood ventilation device further includes a spring formed to rotate the rotary pulley on a hinge shaft, coupled to the hinge shaft at a first end to provide elastic restoring force to the rotary pulley, and coupled to an inner surface of the rotary pulley at a second end.

Further, according to the hood ventilation device of an embodiment of the present disclosure, the filter member has a multi-filter structure in which an outer filter having a shape corresponding to a conical inner filter protruding upward is fitted on the inner filter.

Further, according to the hood ventilation device of an embodiment of the present disclosure, a door hinged to be able to open/close a front of the filter box is formed on the front of the filter box, and the door is made of transparent reinforced glass to be able to show the inside.

Meanwhile, according to the hood ventilation device of another embodiment of the present disclosure, an oil capturing unit for capturing oil removed by the filter member may be mounted in the filter box and the filter box further may have a drain hole for discharging oil, which has been captured in the oil capturing unit, to the outside.

Further, according to the hood ventilation device of another embodiment of the present disclosure, the stretchable tube may be composed of a first pipe and a second pipe that can be inserted a predetermined depth in an end portion of the first pipe, and the second pipe may be configured to be able to adjust a length of the entire stretchable tube while partially moving into or out of the filter box.

In this embodiment, a ball tension cover 125 may be disposed at an overlap of the first pipe and the second pipe.

According to the hood ventilation device of another embodiment of the present disclosure, the stretchable tube may have a grip, which has a ‘ [symbol] ’ or ‘ [symbol] ’ shape cross-section on a surface of a lower portion.

Further, according to the hood ventilation device of another embodiment of the present disclosure, the hood further includes a dirt collection cap connected to a lower end thereof, the hood and the dirt collection cap are detachably connected by a first stopping groove formed at a lower end of the hood and a protruding step formed on an inner side of an upper portion of the dirt collection cap, and the hood and the stretchable tube are detachably connected by a second stopping groove formed at an upper end of the hood and a protruding step formed on an inner side of a lower portion of the stretchable tube.

According to the hood ventilation device of an embodiment of the present disclosure, it is possible to improve the efficiency of removing oil of smoke through multi-filtering, and oil adhering to the filter is guided to the outside of the stretchable tube along the outer surface of a conical shape, whereby it is possible to effectively prevent the inside of the stretchable tube from being contaminated by oil. Further, it is easy to adjust the hood and a grill, so the hood ventilation device can be flexibly used.

### BRIEF DESCRIPTION OF THE DRAWINGS

FIG. 1 is a front view showing a hood ventilation device according to an embodiment of the present disclosure;

FIG. 2 is a side view showing the hood ventilation device according to an embodiment of the present disclosure;

FIG. 3 is a perspective view and a plan view showing a filter box of the hood ventilation device according to an embodiment of the present disclosure;

FIG. 4 is a perspective view showing the state in which a filter member has been installed in the filter box of the hood ventilation device according to an embodiment of the present disclosure;

FIG. 5 is an exploded perspective view showing the filter member of the hood ventilation device according to an embodiment of the present disclosure;

FIG. 6 is an exploded perspective view showing the hood ventilation device according to an embodiment of the present disclosure;

FIGS. 7 and 8 are pictures showing a spring balancer of the hood ventilation device according to an embodiment of the present disclosure;

FIG. 9 is a perspective view showing a hood ventilation device according to another embodiment of the present disclosure;

FIG. 10 is a front view showing a filter box of the hood ventilation device of FIG. 9; and

FIG. 11 is a front view showing a dirt collection cap of the hood ventilation device of FIG. 9.

### DETAILED DESCRIPTION OF THE INVENTION

Terminologies that are generally used at present were selected and used in the present disclosure, but some specific terminologies were freely selected by the applicant(s), and in this case, the meanings of the specific terminologies should be construed in consideration of not simply the names of the terminologies, but the meanings that are described or used in the detailed description of the present disclosure.

For reference, in order to clearly explain the present disclosure in drawings, parts not related to description and parts that those skilled in art can easily understood even they are not described in detail are not described.

The technical configuration of the present disclosure will be described hereafter in detail with reference to preferred embodiments shown in the accompanying drawings.

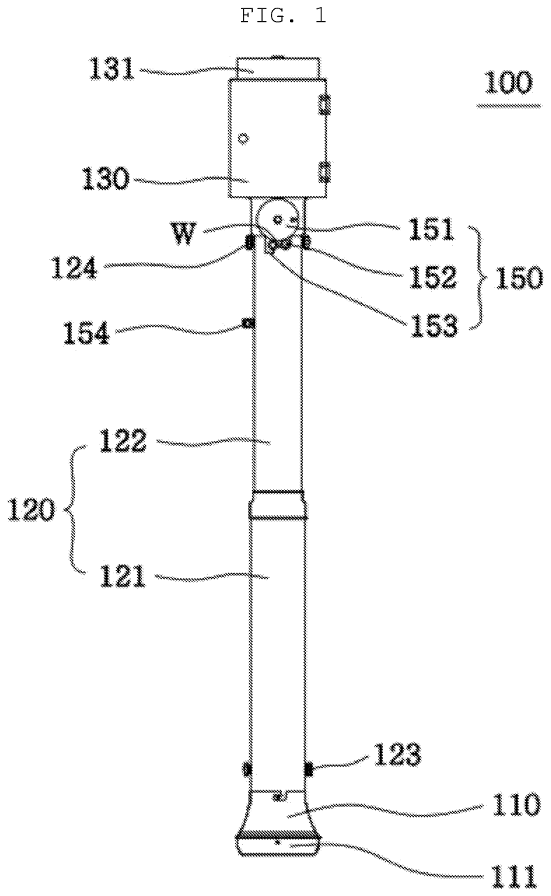

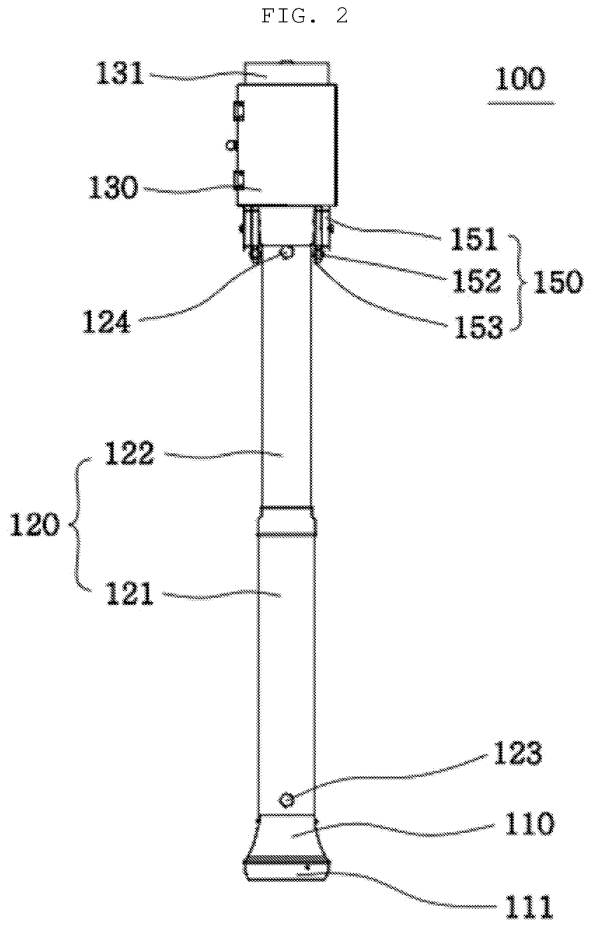

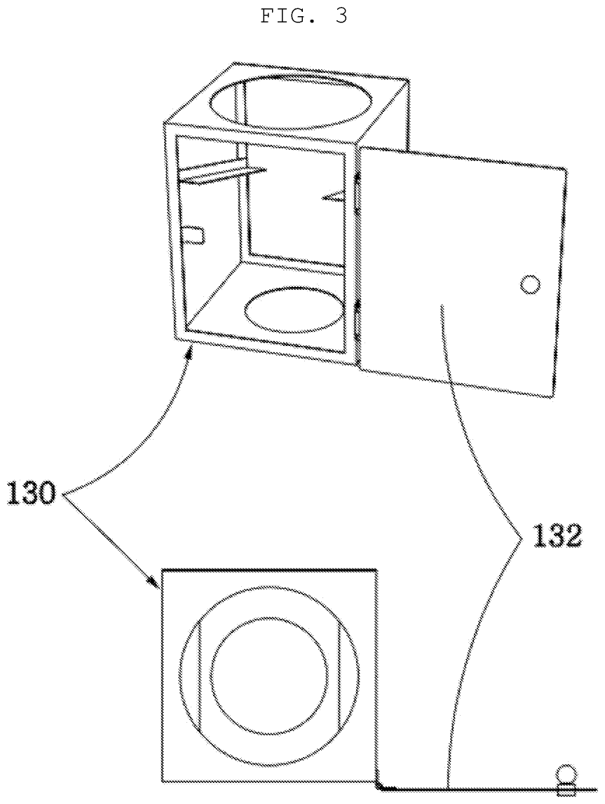

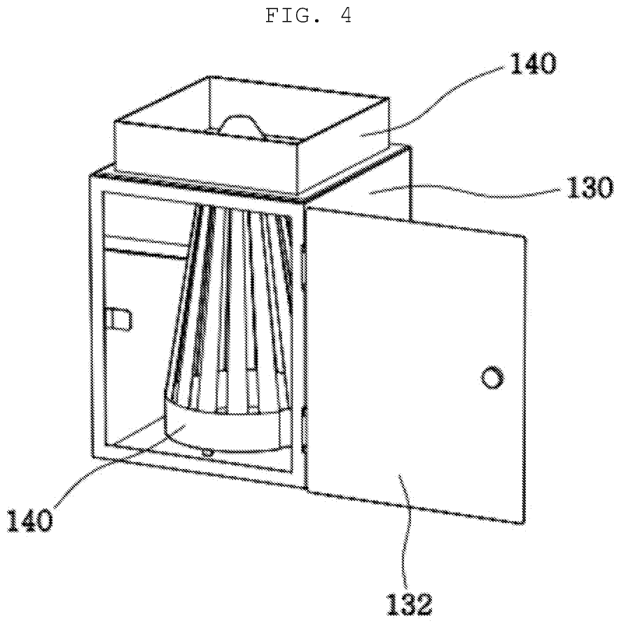

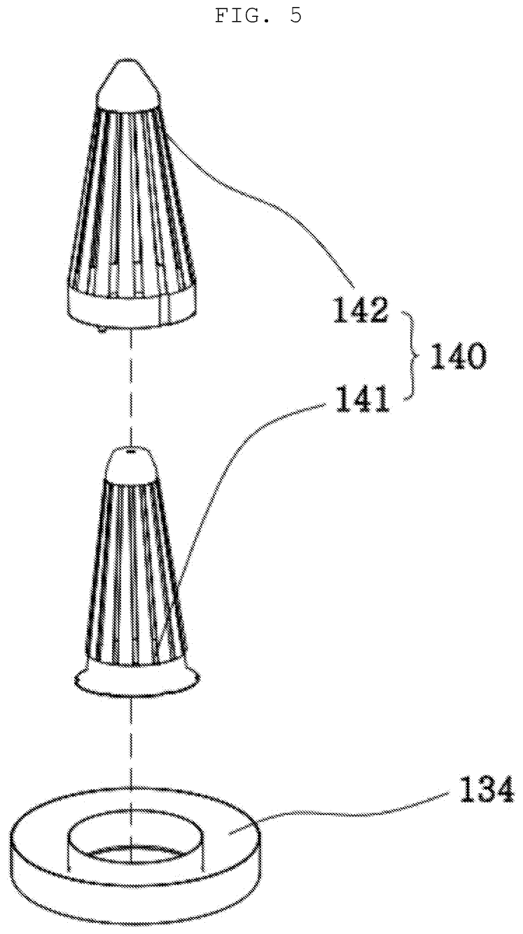

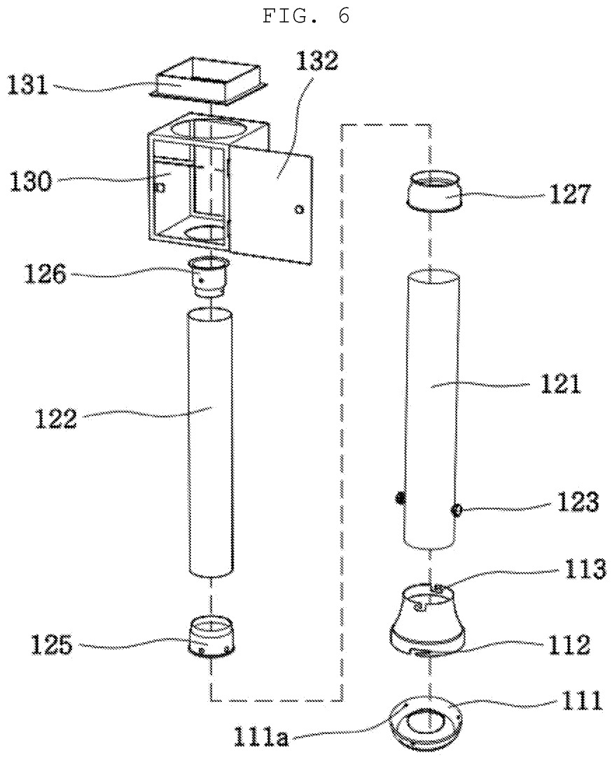

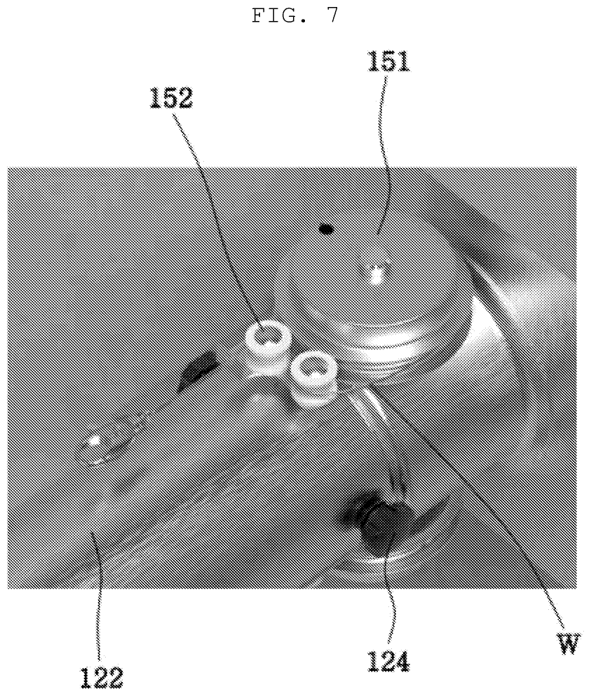

FIG. 1 is a front view showing a hood ventilation device according to an embodiment of the present disclosure, FIG. 2 is a side view showing the hood ventilation device according to an embodiment of the present disclosure, FIG. 3 is a perspective view and a plan view showing a filter box of the hood ventilation device according to an embodiment of the present disclosure, FIG. 4 is a perspective view showing the state in which a filter member has been installed in the filter box of the hood ventilation device according to an embodiment of the present disclosure, FIG. 5 is an exploded perspective view showing the filter member of the hood ventilation device according to an embodiment of the present disclosure, FIG. 6 is an exploded perspective view showing the hood ventilation device according to an embodiment of the present disclosure, and FIGS. 7 and 8 are pictures showing a spring balancer of the hood ventilation device according to an embodiment of the present disclosure.

A hood ventilation device according to the present disclosure is, as shown in FIGS. 1 to 6, a hood ventilation device 100 expanding at an end of a suction unit installed to suction smoke that is produced by a grill. The hood ventilation device 100 includes: a hood 110 positioned over the grill and collecting smoke that is produced when meat or fish is roasted on the grill; a stretchable tube 120 connected at a first end to the hood 110 and adjusting the distance between the hood 110 and the grill; a filter box 130 connected to a second end of the stretchable tube 120 such that the bottom communicates with the second end and having a spoiler 131 mounted thereon to communicate with the top thereof; a filter member 140 mounted in the filter and capturing and removing oil of smoke flowing in the filter box 130 through the stretchable tube 120; and a spring balancer 150 mounted on the outer surface of the uppermost part of the stretchable tube 120, allowing the stretchable tube 120 to move up and down, and fixing the stretchable tube 120 at a predetermined height.

The hood 110 according to an embodiment of the present disclosure is positioned at a predetermined height from a grill and collects smoke, smells, heat, etc. that are produced when food such as meat or fish is cooked on the grill. Further, the hood 110 further includes a dirt collection cap 111 connected to the lower end thereof.

In this configuration, the hood 110 and the dirt collection cap 111, as shown in FIG. 6, may be detachably connected by a first stopping groove 112 formed at the lower end of the hood 110 and a protruding step 111a formed on the inner side of the upper portion of the dirt collection cap 111.

The dirt collection cap 111 is installed at the lower end of the hood 110 and has an air inlet (not shown) formed at the center of the bottom to communicate with the hood 110. In this configuration, the center of the bottom of the dirt collection cap 111 may be recessed a predetermined depth upward and may be formed such that the inner diameter decreases upward from the bottom of the dirt collection cap 111.

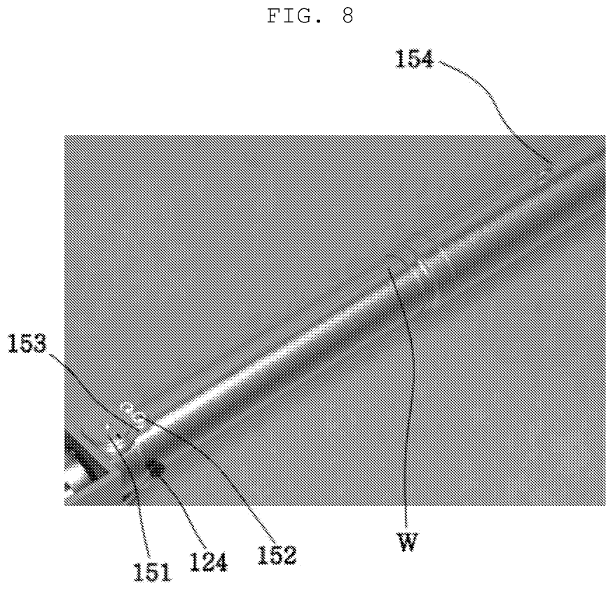

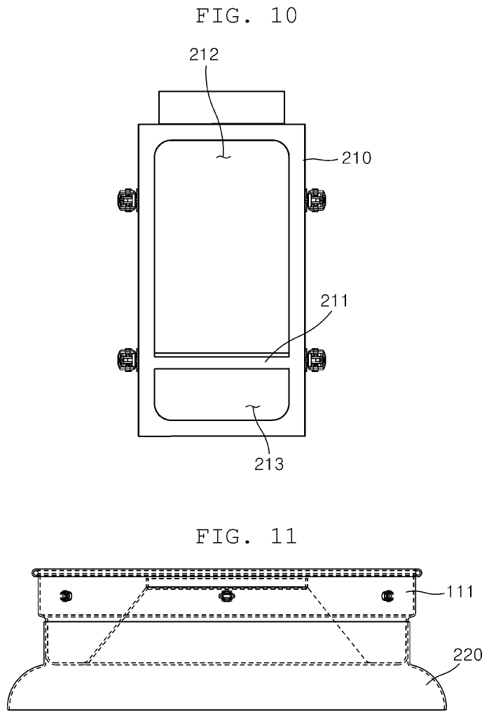

Meanwhile, the dirt collection cap 111, as shown in FIGS. 9 and 11, may have a skirt member 220 at the lower end. The skirt member 220 extends along the edge of the bottom of the dirt collection cap 111 and protrudes downward, and the inner diameter thereof increases downward to increase the amount of air that flows into the hood 110.

The first end of the stretchable tube 120 according to an embodiment of the present disclosure is connected to the hood 110 and performs a function of adjusting the distance between the hood 110 and a grill.

In this configuration, the hood 110 and the stretchable tube 120 can be detachably connected by a second stopping groove 113 formed at the upper end of the hood 110 and a protruding step formed on the inner side of the lower portion of the stretchable tube 120.

Meanwhile, according to the present disclosure, the stretchable tube 120 may be composed of a first pipe 121 and a second pipe 122 that can be inserted a predetermined depth in the end portion of the first pipe 121. In this configuration, the second pipe 122 is configured to be able to adjust the entire length of the stretchable tube 120 while partially moving into or out of the filter box 130.

According to a preferred embodiment of the present disclosure, the entire length of the stretchable tube 120 may be adjusted through the process of loosening a second fixing bolt 124 first, positioning the stretchable tube 120 at a desired height by pulling or unwinding a wire W wound around the spring balancer 150, and then fixing the stretchable tube 120 with the second fixing bolt 124.

According to another embodiment of the present disclosure, the entire length of the stretchable tube 120 may be adjusted, as shown in FIG. 8, by a structure that positions the stretchable tube 120 at a desired height by pulling or unwinding the wire W wound around the spring balancer 150 and has a wire fixer formed on the outer surface of the first pipe 121 such that the second pipe 122 moves a predetermined depth into or moves out of the first pipe 121.

Meanwhile, adjusting the length of the stretchable tube 120 makes it easy to adjust a grill and the hood 110 connected to the stretchable tube 120, which provides an advantage of flexible use.

According to an additional embodiment of the present disclosure, a ball tension cover 125 may be disposed at the overlap of the first pipe 121 and the second pipe 122.

The first pipe 121 and the second pipe 122 can be maintained in a stably coupled state by the ball tension cover 125.

The stretchable tube 120 may further have a grip (not shown in the figure), which has a ‘ [symbol] ’ or ‘ [symbol] ’ shape cross-section on the surface of the lower portion. When the grip is provided, a user can more conveniently adjust the height of the stretchable tube 120 using the grip.

According to the present disclosure, as shown in FIG. 6, a second reducer 127 that is used to connect pipes is disposed at the overlap of the first pipe 121 and the second pipe 122 to connect the first pipe 121 and the second pipe 122.

Meanwhile, referring to FIG. 2, a first fixing bolt 123 and a second fixing bolt 124 are formed at the lower portion and the upper portion of the stretchable tube 120. The first fixing bolt 123 and the second fixing bolt 124 are used to hood 110 when the hood 110 is coupled to the stretchable tube 120 in a fixing bolt type.

The filter box 130 according to an embodiment of the present disclosure, as shown in FIGS. 3 and 4, has a rectangular box shape connected to the second end of the stretchable tube 120 such that the bottom thereof communicates with the second end, and having a rectangular spoiler 131 mounted on the top thereof to communicate with the top.

According to the present disclosure, when the bottom of the filter box 130 is connected to the second end of the stretchable tube 120, as shown in FIG. 6, a first reducer 12 is provided at the joint between the stretchable tube 120 and the filter box 130.

In this configuration, a door 132 that is hinged to be able to open/close the front of the filter box 130 is formed on the front of the filter box 130. The door 132 may be made of transparent reinforced glass to be able to show the inside.

As described above, since the door 132 is formed on the front of the filter box 130, there is an advantage that it is possible to more easily replace the filter member 140 mounted therein and to easily clean the inside of the filter box 130.

Further, since the door 132 is made of transparent reinforced glass, there is also an advantage that it is possible to easily visually check the degree of contamination of the filter member 140 mounted in the filter box 130.

The filter member 140 according to an embodiment of the present disclosure is mounted in the filter box 130 and performs a function of capturing and removing oil of smoke flowing in the filter box 130 through the stretchable tube 120.

In particular, according to the present disclosure, the filter member 140, as shown in FIG. 5, is characterized by having a multi-filter structure in which an outer filter 142 having a shape corresponding to a conical inner filter 141 protruding upward is fitted on the inner filter 141. According to this multi-filter structure, it is possible to greatly improve the efficiency of removing oil in smoke through multi-filtering.

In addition, since the filter member 140 is formed in a conical shape protruding upward, the oil adhering to the filter is guided to the outside of the stretchable tube 120 along the outer surface of the conical shape, whereby it is possible to effectively prevent the inside of the stretchable tube 120 from being contaminated by oil.

Meanwhile, in the present disclosure, the material of the filter member 140 is not specifically limited, but, preferably, the filter member 140 may be made of stainless steel having high durability and being strong against heat.

According to an additional embodiment of the present disclosure, an oil capturing unit 134 for capturing oil removed by the filter member 140 may be mounted in the filter box 130.

The oil capturing unit 134 is coupled to the lower portion of the inner filter 141 and has a hole (not shown) formed at the center so that air flowing in the filter box 130 through the stretchable tube 120 flows to the inner filter 141 therethrough. Further, the oil capturing unit 134 has a collection space for collecting oil at the upper portion. The collection space extends in a ring shape around the hole and is open at the top.

Further, the filter box 130 may further have a drain hole (not shown in the figures) for discharging oil, which has been captured in the oil capturing unit 134, to the outside.

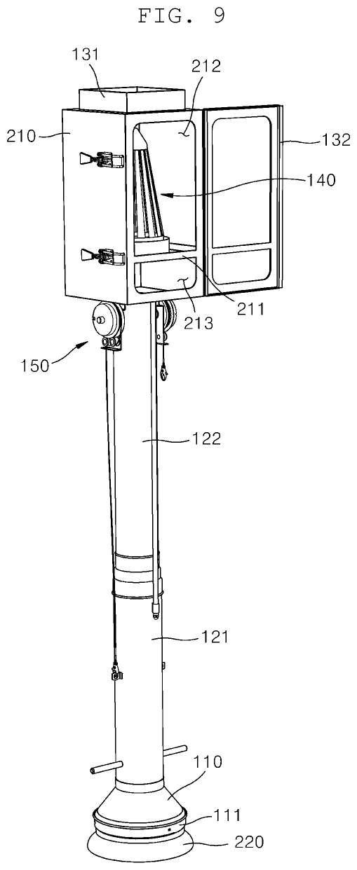

Meanwhile, another embodiment of the filter box 210 is shown in FIGS. 9 and 10.

Referring to the figures, the filter box 210 has a separation plate 211 that can separate the internal space up and down into a first unit space 212 and a second unit space 213.

The separation plate 211 is formed in a plate shape having a predetermined thickness and has a through-hole (not shown) formed in the up-down direction through the center. The filter member described above is installed in the first unit space 212 at the upper portion and the stretchable tube 120 is connected to the filter box 210 to communicate with the second unit space 213. In this configuration, though not shown, an extinguishing device that can sense or extinguish a fire may be installed in the second unit space 213. Since the internal space of the filter box 210 is separated into a plurality of spaces by the separation plate 211, as described above, it is possible to secure a space in which not only the filter member, but the extinguishing device can be installed.

The spring balancer 150 according to an embodiment of the present disclosure is mounted on the outer surface of the uppermost part of the stretchable tube 120 and performs a function of allowing the stretchable tube 120 to move up/down and fixing the stretchable tube 120 at a predetermined height.

In more detail, the spring balancer 150, as shown in FIGS. 7 and 8, has a rotary pulley 151 on which a wire W is wound and that is formed on the outer surface of the uppermost part of the stretchable tube 120, and may include a bracket 153 disposed under the rotary pulley 151 and having a plurality of guide rollers 152 for guiding the wire W wound on the rotary pulley 151 to a fixing portion 155 formed under the bracket.

Further, the rotary pulley 151 may further include a spring formed to be rotated on a hinge shaft, coupled to the hinge shaft at a first end to provide elastic restoring force to the rotary pulley 151, and coupled to the inner surface of the rotary pulley 151 at a second end.

According to the present disclosure, the spring balancer 150 may be installed only at a side of the outer surface of the uppermost part of the stretchable tube 120 or may be installed at each of a side and another side of the outer surface of the uppermost part of the stretchable tube 120.

When the spring balancer 150 is installed at each of a side and another side of the outer surface of the uppermost part of the stretchable tube 120, the stretchable tube 120 can be more stably moved without shaking due to influence of external force.

Although embodiments of a hood ventilation device according to the present disclosure were described above, the embodiments are provided to exemplarily describe preferred embodiments of the present disclosure without limiting the present disclosure. Further, it is apparent that those skilled in the art can modify and copy the present disclosure in various ways without departing from the spirit of the present disclosure.

What is claimed is:

1. A hood ventilation device that expands at an end of a suction unit installed to suction smoke that is produced by a grill, the hood ventilation device comprising:
a hood positioned over the grill and collecting smoke that is produced when meat or fish is roasted on the grill;
a stretchable tube connected at a first end to the hood and adjusting a distance between the hood and the grill;
a filter box connected to a second end of the stretchable tube such that a bottom thereof communicates with the second end and having a spoiler mounted thereon to communicate with a top thereof;
a filter member mounted in the filter box and performing a function of capturing and removing oil of smoke flowing in the filter box through the stretchable tube; and
a spring balancer mounted on the outer surface of an uppermost part of the stretchable tube, allowing the stretchable tube to move up and down, and fixing the stretchable tube at a predetermined height.

2. The hood ventilation device of claim 1, wherein the spring balancer has a rotary pulley on which a wire is wound and that is formed on an outer surface of the uppermost part of the stretchable tube, and includes a bracket disposed under the rotary pulley and having a plurality of guide rollers for guiding the wire wound on the rotary pulley to a fixing portion formed under the bracket.

3. The hood ventilation device of claim 2, further comprising a spring formed to rotate the rotary pulley on a hinge shaft, coupled to the hinge shaft at a first end to provide elastic restoring force to the rotary pulley, and coupled to an inner surface of the rotary pulley at a second end.

4. The hood ventilation device of claim 1, wherein the filter member has a multi-filter structure in which an outer filter having a shape corresponding to a conical inner filter protruding upward is fitted on the inner filter.

5. The hood ventilation device of claim 1, wherein a door hinged to be able to open/close a front of the filter box is formed on the front of the filter box, and
the door is made of transparent reinforced glass to be able to show the inside.

6. The hood ventilation device of claim 1, wherein an oil capturing unit for capturing oil removed by the filter member is mounted in the filter box.

7. The hood ventilation device of claim 6, wherein the filter box further has a drain hole for discharging oil, which has been captured in the oil capturing unit, to the outside.

8. The hood ventilation device of claim 1, wherein the stretchable tube is composed of a first pipe and a second pipe that can be inserted a predetermined depth in an end portion of the first pipe, and
the second pipe is configured to be able to adjust a length of the entire stretchable tube while partially moving into or out of the filter box.

9. The hood ventilation device of claim 8, wherein a ball tension cover is disposed at an overlap of the first pipe and the second pipe.

10. The hood ventilation device of claim 1, wherein the stretchable tube has a grip, which has a ‘ [symbol] ’ or ‘ [symbol] ’ shape cross-section on a surface of a lower portion.

11. The hood ventilation device of claim 1, wherein the hood further includes a dirt collection cap connected to a lower end thereof, and
the hood and the dirt collection cap are detachably connected by a first stopping groove formed at a lower end of the hood and a protruding step formed on an inner side of an upper portion of the dirt collection cap.

12. The hood ventilation device of claim 1, wherein the hood and the stretchable tube are detachably connected by a second stopping groove formed at an upper end of the hood and a protruding step formed on an inner side of a lower portion of the stretchable tube.
